(19) United States
(12) Patent Application Publication
(10) Pub. No.: US 2010/0114696 A1
(43) Pub. Date: May 6, 2010

(54) METHOD OF PROGRAMMED ALLOCATION OF ADVERTISING OPPORTUNITIES FOR CONFORMANCE WITH GOALS

(75) Inventor: Jian Yang, Palo Alto, CA (US)

Correspondence Address: Mauriel Kapouytian & Treffert LLP, 151 1st Avenue, #23, New York, NY, 10003, US

(73) Assignee: YAHOO! INC., Sunnyvale, CA (US)

(21) Appl. No.: 12/262,511

(22) Filed: Oct. 31, 2008

(51) Int. Cl. G06Q 30/00; G06F 17/30; G06Q 90/00

(52) U.S. Cl. 705/14.49; 705/10

(57) ABSTRACT

An advertising server allocates advertising impressions to meet advertisers' demands for opportunities to run advertising, for example ad content inserted into Web pages for payment. Supplies of advertising impressions are paired by their characteristics with demands that the supplies could meet. For paired eligible supplies and demands, an ideal allocation is determined, between zero and a maximum. The ideal allocations for all pairs are the coordinates of a utopia point in multidimensional space, although meeting all these ideals is likely to be impossible because of practical constraints. Using optional weighting, candidate allocations are tested or compared. Each candidate allocation produces coordinates in the multidimensional space. The candidate allocations are compared, based on the relative proximity of their coordinates to the potentially-impossible utopia point in multidimensional space. A ranking is stored or the selected allocation is executed, under control of a programmed processor.

### FIELD OF THE INVENTION

The disclosure relates to programmed processes for allocating a supply of opportunities to present advertising, among competing demands for use of the opportunities.

### RELATED ART

A robust market exists for distribution of information such as advertising. One objective of advertisers is to deliver information specifically to subjects who are likely to be interested in the information or influenced by it, and to minimize delivery of ads to subjects who are not at all interested. Often it is possible to target advertising by presenting the advertising in association with specific media content because persons with particular interests are drawn to particular types of media content. It is possible to insert selected advertising pieces very readily into media that is being distributed electronically.

One cannot be sure that any given subject will purchase a product or service if exposed to advertising. But an advertiser can establish sets of characteristics that distinguish among subsets of a population, determine values of those variables that are associated with actual or likely purchasers, and by statistical methods correlate a selected subset of the population with variable values consistent with purchasers. This process enables subsets of the population to be rated as to the likelihood that members of the subsets will become purchasers if exposed to advertising.

Various characteristics might distinguish a pertinent subset of the population and correlate with an ideal target for a particular advertising piece more than some other subset. However, the subsets correlated to advertising targets very often overlap. For example, subjects in a category, such as parents of college students, might be targeted by selecting for characteristics such as: visitors to a financial commentary for stock traders on the web, aged 45 to 55, with dependents. Parents of students might also be targeted by selecting for: mothers of 18 year olds, living in urban zones of the US, who are visiting college web sites. An advertiser may direct advertising to a variety of groups of the population according to overlapping characteristics. The content of the media correlates with some of the characteristics. The nature of the media, such as web surfing to certain sites or access to cable television or other media distribution channels containing certain programming, carries ways for classifying users and viewers as to their location, characteristics and viewing or web surfing habits.

It may be inconsistent with the objectives of advertisers to concentrate advertising exclusively on a narrow subset of the population even if that subset has a high correlation with likely purchasers. Furthermore, it is generally not practical or possible to provide a set of characteristics so discriminating that a large proportion of likely purchasers are positively included and a large proportion of unlikely purchasers are positively excluded. Instead, the advertisers select subsets of the population by combinations of characteristics that are believed to select for the groups that are targeted.

Some of the characteristics may be demographic, such as age, gender or location. Some characteristics may relate to user interests. The information to classify users by such characteristics may be derived from the fact that users are found to be visiting web sites or searching or viewing content or making purchases that indicate an interest. The characteristics may include aspects of users' past activities, insofar as such characteristics can be determined, for example by separately maintained databases, by accessible browsing history information, cookies stored on the user's system, etc.

Media outlets have access to some information that characterizes their users, and the correlation between media content and users as potential targets of advertising is analyzed by advertisers. The manner in which advertisers determine a correlation between media users' characteristics and the advertisers' desired subset of the population for targeting ads is beyond the scope of this disclosure. Nevertheless, advertisers are deemed to know who they want to target, according to broad or narrow criteria. The advertisers' criteria select and exclude users according to at least some of the same user characteristics that web site operators or other media distributors can learn, detect, infer or otherwise acquire when a user obtains access to the media in one way or another.

The market for inserting advertising on the Internet when transmitting html web pages is particularly apt, although the techniques disclosed herein are not limited to the Internet or to similar interactive network applications. The content of media sought out by users is useful to characterize the users. Infrastructure is in place for changeably inserting ad graphics and moving pictures, such as Internet browsers. Data from click streams, browser histories, and locally stored cookies can carry context and history information forward in time as the user surfs through different pages. Internet service providers may collect and make available general or specific information on subscribers routinely, such as subscribers' zip codes. These information sources enable information to be collected to gauge the characteristics of users and enable an advertiser to define a representative advertising allocation for which the advertiser will contract.

Media distributors such as webpage operators collect information and can report to potential advertisers as to the number or proportion of users available through a given web page or the like, who meet characteristics sought by the advertisers. This information enables the advertisers and the media distributors to negotiate arrangements whereby opportunities that arise to present advertising to users can be evaluated and priced. The media distributors undertake to determine or infer characteristics of users when the users actually obtain access to a webpage or other media. The media distributor inserts an advertising piece into the media content when distributed, which piece has been selected for the user by the advertiser, based on the user's characteristics.

Each presentation of an inserted advertising piece to a user is termed an “advertising impression” or an “ad impression.” The characteristics of the user are important, and each ad impression can be associated with the characteristics of the user to whom the ad was presented. Accordingly, the media supplier can project or estimate a number of ad presentation opportunities, defined as a function of user characteristics. An advertiser may contract with the media supplier to use a certain number or proportion of those opportunities to execute ad impressions over a certain period of time, likewise defined by the characteristics of the users. There is a supply and a demand, potential contractual obligations, performance of the obligations, billing and accounting, etc. All these are related to the delivery of ad impressions, defined by the characteristics of the users to who the ads are presented.

Therefore, an advertiser may contract with an advertising distributor to use impressions that are available to the distributor, who may be a media distributor or an agent who deals with media distributors or an operator of an advertising warehouse. A supply of available impressions is defined by numbers and user and/or media attributes that determine the value of the impressions to the advertiser.

Challenges arise when one attempts to put the foregoing plan into practice. Among other issues, the manner in which advertisers define subsets of the population as representative advertising targets, namely users who meet selection criteria, can produce overlapping subsets. For example, female teenagers, high school students, fans of popular music, cosmetics buyers, and fashion magazine subscribers, are categories with some overlap. An advertiser might try to reach one or more of the categories by selection of others. A media supplier may only be able to determine user characteristics up to a point. For example if it is known that a user is a high school student, it is only 50% likely that a user is female. An advertiser may have Boolean combinations that are complex. For example a trade school operator may be seeking teenagers (etc.) who are not high school students.

In the end, there are supplies of ad impressions that define various population subsets. There are advertiser criteria that define a demand for ad impressions tied to various population subsets. Some technique is needed to allocate the supply of ad impressions to meet the demand. However the supplies may include the same persons defined in alternative ways or statistically correlated ways. An advertiser may reasonably select simple or complex criteria related to subsets, including concatenated combinations of criteria that are to be met, Boolean combinations of criteria that define inclusions and exclusions, ranges of values, preferences that may favor one defined subset over another.

It would not be helpful to allocate supply to demand based only on the extent to which an advertiser's highest priority user attributes are met, because that could starve all other priorities. If a particular advertiser is a high priority, it is not advisable to serve only that advertiser. It is not advisable to ignore the fact that some impressions are distinctly more valuable to advertisers than others, and if so, those impressions might be allocated more sparingly than others. It would be appropriate in some instances where a demand might be served by any of several supplies to spread the allocation over the several candidates. Where allocation candidates have different values, they might be distributed randomly or by a weighting scheme or in proportion to the number available units. What is needed is some practical way to determine and quantify the number or proportion of ad impressions that will be allocated from each definable subset of ad impression supplies to meet each demand, that is appropriate in view of the overlapping and differing values of the supplies to the advertisers, and meets advertiser needs to apply advertising revenues to spread ad impressions over a representative profile of targeted users.

### SUMMARY

A technique is provided herein to make a practical resolution of such allocation issues, by initially defining a set of ideal or utopian allocations between each demand and each supply that is a candidate for meeting the demand. If no other consideration is available, the ideal allocation may be that number or proportion of the supply that spreads the supply evenly across the instances of demand, e.g., sharing proportionately by the number of supplies versus the number of demands, or sharing in proportion to the number of supply units available and thus allocating based on availability. Where there is a distinctly different value associated with two or more supplies, the ideal allocations might be determined based on value, i.e., zero for the most valuable and 100% for the least valuable.

Constraints are included that can render the ideal allocations unfeasible, but the allocation technique works nevertheless. The constraints require that the entire demand be met from the supplies, for example. Setting an ideal allocation of zero from every supply to every candidate (i.e., conserving all the supplies) is a potential ideal. In another example, the ideal supplies could be selected in other ways. In any event, for each possible allocation pairing, between each of the supplies and each eligible demand, an ideal allocation is predetermined. Certain demands optionally can be made ineligible for certain supplies.

By data processing techniques, a multi-coordinate space is defined, wherein each coordinate axis represents a pairing between an eligible supply and an eligible demand. Points along the coordinate axis represent a measure of allocation from that supply to that demand. The coordinate axes can be accorded different weights to distinguish a value or other distinguishing aspect of one allocation from a supply to a demand, versus another. The predetermined ideal allocation for a given supply to a given demand is a point along the corresponding axis in multi-dimensional space, somewhere between zero and the full amount of the eligible supply. In the multi-coordinate space, the ideal allocations of all the eligible supplies and demands is a single point.

By data processing techniques, a plurality of possible allocations between the eligible supplies and demands are tested to determine one or more allocations that best matches all the ideals. Preferably, all the possible allocations are tested. Every possible set of allocations between all the supplies and all the eligible demands represents a point in multi-coordinate space. However, not all the points in multi-coordinate space are possible. This is true because in cases where portions of a supply can be allocated to two or more demands, increasing the allocation to one of the demands has the effect of decreasing the quantity and proportion of that supply that remains available for allocation to another demand.

Testing for an optimal allocation comprises applying a norm function as discussed in detail hereinafter. Alternative norm functions are disclosed, each generally involving ways to assess a distance in multi-coordinate allocation space between the point corresponding to a proposed allocation and the point corresponding to the ideal allocation. Each proposed allocation has corresponding coordinate values for all possible allocations connecting the supplies and the eligible demands, and thus corresponds to the proposed allocation point. It is possible to test all possible allocations and to determine one or more allocations that are the closest to the ideal as defined by the ideal point in multi-coordinate allocation space. Alternatively, the technique can be employed to determine which of two potential allocations is nearer to the ideal, or to rank a plurality of allocations in order of their proximity to the ideal point.

Accordingly, a set of opportunities is provided for insertion of some number and type of ad impressions into media and constitutes a supply to be allocated to the demands of advertisers. The number and type can be estimates projected for a future time, for example when planning an optimal allocation. Alternatively or in addition, the number and type can be monitored while controlling current operations, and repetitively or periodically updated. The opportunities can involve space reserved for an ad in a webpage and infrastructure to insert a banner ad, graphic or hyperlink selected by an advertiser when the webpage is transmitted to a user's browser. Similarly, commercial ad clips might be inserted into time slots reserved in entertainment over a cable or wireless network.

Characteristics of the user or viewer base are known, at least by association with the theme or content being presented by the web page or media entertainment program, and preferably also in other ways. Alternative sets of criteria based on the characteristics are used to define discrete supplies or subsets of users.

Likewise competing demands to use the supplies, namely to present ad impressions to users, are received from or generated for advertisers. The demands each comprise a desired number or proportion, and a set of criteria that can be applied against the characteristics associated with the supplies to determine if a respective supply is eligible to meet a demand. The demands may overlap various available sources of supply. Depending on the situation, a given supply may be deemed eligible to meet a demand, according to advertisers' requirements, even if the match between the demand specifications and the supply characteristics is only partial. In any event, there is a logical link made between each supply that is eligible to meet each demand.

The disclosed process associates supplies with demands and metes portions of the supplies to plural demands, so as to comply with constraints and additionally to best achieve goals that are better served by some allocations than by others. The allocation constraints include ensuring that each demand is met from the sum of allocations from one or more of the supplies. Among the allocation goals are economy and conservation, achieving representative distributions of ads over populations where possible, weighting distributions of ads based on characteristics of supplies and demands, and similar goals.

In a multi-dimensional allocation space, an axis is logically inferred and embodied in programming, wherein each axis corresponds to the association of one of the supplies with one of the demands. Along the axis, each point represents a quantity of the supply to be allocated from the supply to the demand. The quantity can be expressed as a stored value in memory for a proportion of the available supply, or a number of supply units (e.g., a number of ad impressions), or an associated revenue. The quantity can have a corresponding weighting factor whereby the product of the weight and the number of supply units is the stored value to be compared. Weighting allows some allocations to be considered more important than their unit number, namely by use of a weighting factor greater than one, or less important by use of a weighting factor that is a fraction.

Ideal or utopian amounts or proportions for the allocations from every possible supply to every possible demand are defined. These allocations can include ideals that might serve one or more of goals, especially goals of the advertiser or the media distributor, but at the same time might be impractical or not feasible in combination. For example, all supplies of a particularly valuable category of supply might be accorded an ideal allocation of zero so as to conserve their value, but at the same time, it could be known that some of these supplies will have to be allocated in order to ensure that the demand is met.

Each potential set of allocations defines a point in multi-dimensional allocation space. Certain constraints apply including meeting all the demands from the supplies. Also, preferences apply in some cases determined by weighting and in some cases dictating spreading the demands over the supplies rather then permitting any one demand to hog any one supply. As a result of the constraints, weights and preferences, any marginal changes such as increasing the amount of supply allocated from a given supply to a demand, has a ripple effect, reducing the remainder available in that supply for allocation to other demands, and decreasing the amount that other supplies pay into supplying that demand.

At least one potential allocation is compared for correspondence with the ideal values of all allocations by a norm function determining the distance in multi-dimensional space from the point corresponding to the potential allocation to the point corresponding to all the ideal or utopian allocation values between each eligible supply and demand. Preferably at least two potential allocations are compared, and the allocation chosen is the one that has a corresponding point that is closer than the other to the point corresponding to the ideal or utopian values. Optionally, all possible combinations of allocation between the supplies and the demands are tested and ranked for their relative proximity to the ideal utopian point.

The result of this comparison of one or more sets of allocations, or data representing the rankings of two or more or all allocations, are stored in memory and are the basis for planning and executing the allocation of ad impressions. When the comparison is based on projections and estimates of supplies and demands, the allocations are used to plan for future delivery of ad impressions. The stored data is useful, for example to facilitate negotiations between media distributors and advertisers or their agents, assisting in assessing the overall sizes of supply and demand, to enable setting of prices and to support competition for the supply of advertising impressions. When the comparison is run during actual allocation operations, each delivered ad impression reduces an associated supply and satisfies an associated demand. Repetitively or periodically or upon request, the planned and executing allocations can be reassessed and adjusted as necessary to control the allocation procedure to the optimal proportions determined as described above.

It is an object of the present disclosure to provide a technique whereby a match can be made efficiently and with a high degree of optimization, between individual instances of supply of a resource and specified demands. The supplies preferably are available or prospectively-available advertising impressions and are defined in part by number, type and a set of characteristics associated with content and user attributes. Instances of demand likewise are determined by a definition of a representative demand profile, containing criteria that if satisfied by a supply will render the supply eligible to supply the demand. The advertisers' representative demand profiles also can have other specifications. For example, the advertiser may specify that if other things are equal, a demand should be distributed over the number of supplies or over the total quantity of all the supplies, etc. The advertiser alternatively may specify preferences that go into determining the weights that can be applied to make one or more allocation paths from supply to demand more important than other paths in the process for comparing alternatives to determine the optimal combination of allocations.

This and other objects are met by an inventive advertising server method and system that allocates advertising impressions to meet advertisers' demands for opportunities to run advertising, for example ad content inserted into Web pages in exchange for payment. Ad impressions are opportunities to present an advertising piece to a user or viewer, and each ad impression is associated with values for characteristics describing the user/viewer, the page content or context, possibly the user/viewer's location, available history and demographic information and the like. At least some of the same variables are used to define the advertisers' requirements, according to representative profiles that target potential customers and distribute ads over media users. Accordingly, it is possible to determine whether a given supply is eligible to contribute supply units (ad impressions) to meet the requirements of a specified demand for a certain number of ad impressions with specified characteristics.

In a best case, all the available ad impressions might have highly statistically significant known value for all the same variables that are used in the demands to specify the ad impressions that will meet the demands. In the real world, however, values for at least some of the same variables are known for multiple ones of the supplies and are least known to be correlated to some degree with variables used in the specifications of multiple ones of the demands. Based on meeting some threshold of a match (for example if it is more likely than not that a majority of the increments of a supply meet the demand specifications) a conclusion is reached that the supply is eligible to contribute incremental units (ad impressions) to meet the demand. In the event that a high statistical significance or a close match or a critical variable value is met by some supplies that are deemed eligible to meet a demand, the allocation from that supply to that demand can be adjusted by applying a strong weight, making the allocated supply units relatively more important than less weighted allocations from other supplies. Also, if the supply is very well suited to the demand, the ideal or utopia point should be set to favor allocating a high proportion of that supply to its well suited demand.

In this way, the advertisers have versatility with respect to the criteria that define the representative profile of desirable ads. The relative value and suitability of the different possible allocations are taken into account in a manner that is automated and fast. Lopsided associations of certain supplies with certain demands is prevented or permitted in a disciplined way. Keeping in mind that allocation of a supply to one demand reduces that remainder of the supply available for allocation to other demands and that supplies and demands may be of unequal value, suitability or importance, the disclosed technique enables a logical and optimal allocation to be chosen and executed.

### BRIEF DESCRIPTION OF THE DRAWINGS

The drawings depict several embodiments as examples, it being understood that the invention is not limited to the embodiments disclosed as examples and is capable of variation within the scope of the appended claims. In the drawings,

FIG. 1 is a schematic block diagram showing the associated entities, computing elements and program storage, indicating the routes of information and consideration exchange.

FIG. 2 is a block diagram showing application to a programmed system wherein a projected supply of ad impressions subdivided by a level of confidence in the projections, part being guaranteed and part being reserved for exchange at auction.

FIG. 3 is flow chart illustrating certain exemplary steps.

FIG. 4 is an illustration of an allocation with plural ad impression supply sources that are allocated to a demand.

FIG. 5 is an illustration corresponding to FIG. 4, except there are simultaneous possible allocations from plural ad impression supplies to plural demands, and at least one constraint is applied with respect to whether a given supply is potentially allocated to at least one of the plural demands.

FIG. 6 is a schematic illustration of determining the proximity of a point in multi-coordinate space corresponding to the arrangement of FIG. 5, to a utopia point defined by ideal allocations in the respective pairs of supplies and demands as shown.

### DETAILED DESCRIPTION

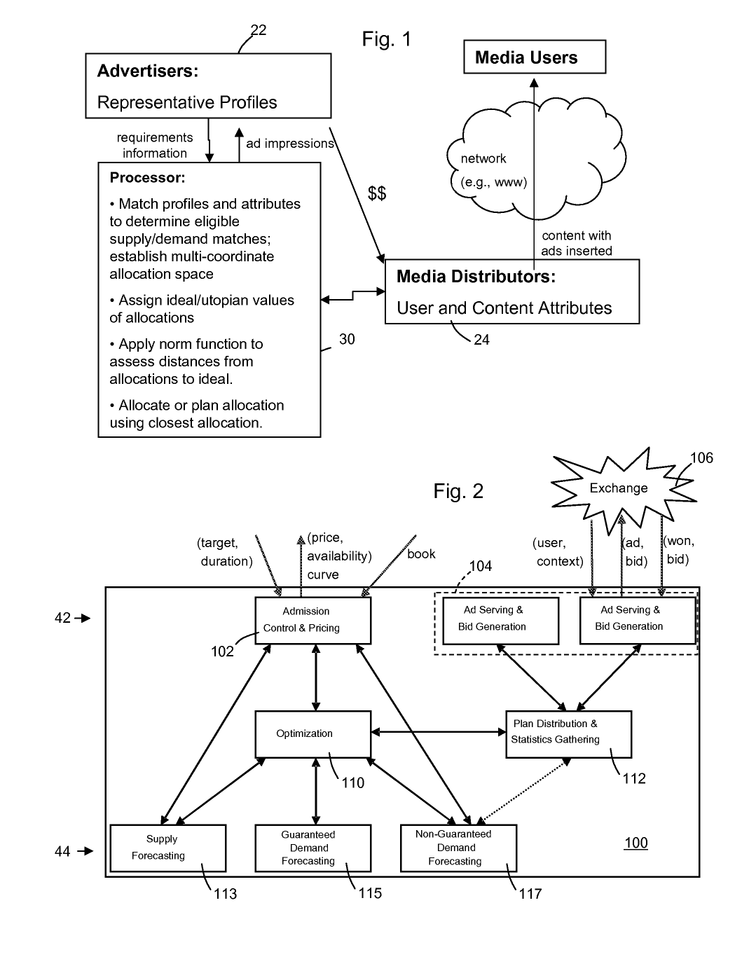

FIG. 1 generally illustrates an embodiment wherein advertisers who desire to present advertising according to representative profiles, cooperate through an advertising supply-and-demand allocation service running on one or more processors. The advertisers are willing to pay the media distributors for the opportunity to insert ads into media viewed by users, the media content and the users being distinguishable by particular attributes. The number and attributes of ad impressions sought constitutes one or more demands that are distinguishable by such attributes. The available ad impressions with particular attributes constitute one or more supplies.

The ad impressions are of value to the advertisers in an amount that varies with the number of ad impressions that are used and with the quality of the ad impressions in the estimation of the advertisers. The media distributors have information on attributes that characterize their active users, including but not limited to knowledge of the content of the media that the users are obtaining over their data communication or entertainment networks and may have knowledge of the context of how the user came to arrive at the media. In part, the users are defined by their interest in the particular content of the media that is presented and the ad impressions are defined by the users that view them. Distinct content, and therefore distinct users, may be available and accessible to ad impressions when visiting different entities' webpages of different webpages of the same entity, or the same webpage at different times or when devoted to different subject matter.

One objective is to determine the characteristics of ad impressions, which may involve the content of a particular media presentation, a description of the statistical range of users of that content, specific information about a given user who is being linked to the media, etc. A supply of ad impressions with distinct attributes as thereby determined is available to serve demands of advertisers. The advertisers have criteria based on a set of characteristics that define the ad impressions desired. For example, the advertisers may seek to reach a certain age group, interest group, users with a particular history, users in some geographic location, and Boolean combinations of such attributes. Plural advertisers might be served simultaneously from the supplies of ad impressions. The advertisers can each have a target representative profile of characteristics and can compete with other advertisers.

A given advertiser can have a representative profile with criteria that include more than one combination of attributes. Often, multiple criteria overlap such that some of the same users and ad impressions meet the criteria of one advertiser or one combination of attributes and also meet the criteria of others. In this situation, the supplies of ad impressions having given characteristics may be eligible to contribute to supplying more than one demand. Each demand may draw ad impressions from more than one supply. There is competition and an allocation is needed by which some number or proportion of one or more of the supplies satisfied all or part of one or more demands.

The processor can be part of a service that operates in exchange for a share of the revenue or a service that is carried on by a media supplier. The processor matches the representative profiles and demands of the advertisers against the attributes of the supply of available ad impressions. In the event that a supply is deemed eligible to contribute to a demand, the problem arises as to how much of the supply from a given source of supply should be allocated to which of the demands.

A supply is defined at least partly by typical or actual user attributes and content attributes. A demand likewise is defined at least partly by specifications as to attributes of users and/or content that the advertiser seeks to target. The selection of ad impression attributes and the advertiser specifications is a complex matter of statistics and psychology and need not be discussed in detail in this disclosure. Also the specific functions by which one concludes that a supply shall be deemed eligible to meet a supply need not be detailed. The supplies and demands at least partly align with one another so that some of the supplies are deemed appropriate candidates for meeting more or less complicated tests such as required sets of thresholds for one or more variable values. Ratings as to preferences are also possible, wherein supplies may be appropriate candidates if the supplies are favorably related on two or more variables considered in combination.

Having established that two or more supplies are candidates to meet a demand, it would be possible simply to allocate all of the first supply encountered to all of the first demand encountered until the demand is met or the supply exhausted and then to move on to the next supply and demand. This is not a suitable allocation for distributing advertising. A preferred allocation for advertising typically spreads supplies over demands and vice versa. By spreading an allocation over multiple candidate matches of supplies to demand, the representative distribution profiles that are desired by advertisers are best followed. At the same time, it is desirable that the allocations take into account the differences in value of supplies, and the extent to which individual supplies fill demand specifications that are most important to the advertisers.

According to examples disclosed herein, a multi-dimensional allocation space is established according to the programming of a data processing system. The coordinate axes of the multi-dimensional allocation space correspond to the allocation from one of the supplies to one of the demands. The points along each axis correspond to a quantity allocated from that supply to that demand. The quantity of the allocation can be represented in data memory as a number of supply units (ad impressions), a proportion of the supply units that a supply can produce, a revenue from supplied ad impressions, or similar measures of quantity. In determining the measure of quantity, the quantity units can be weighted by application of a weighting factor. The weighting factors can be different for every paired supply and demand. The weightings can be greater than one, to enhance the importance and the measure of the amount of the allocation, or can be a fraction to reduce the importance of a comparable number of units. In any event, an allocation in a given amount from each supply to each eligible demand, corresponds to a point along one of the axes of multi-dimensional allocation space.

The supplies are finite quantities. Any allocation of an amount from a supply to a demand reduces the amount remaining to be allocated from that supply to other demands. A suitable allocation should spread each supply over multiple demands (and vice versa). If the quantity allocated from a supply to one of the demands is increased, the quantity allocated from the supply to one or more of the other demands is decreased by the same total amount.

In order to determine an optimum allocation, one step is to assign an ideal allocation between particular supplies and demands. In addition to weighting, the selection of an ideal allocation is a way to discriminate among particular supply and demand allocation routes. The ideal allocation for all the supply/demand connections or allocation routes could be zero, because the media distributor ideally wants to reserve the supplies, but this would not provide a guide to determine whether one allocation route is preferred over another. Another ideal allocation might be to set the allocation as equal divisions of the supplies among the number of demands to which they are coupled. This would not account for the fact that the demands might be seeking unequal quantities or total value of ad impressions. Preferably, some attention is paid to servicing the special interests of advertisers and media suppliers by selecting ideal allocations to meet goals.

If a supply is of particular value to the media distributor, for example because it is known to be in high demand by certain advertisers only, it can be accorded a low or zero allocation as its ideal allocation in the case of all other advertisers. An advertiser's preferences for specific user or media content attributes can be served by providing a higher ideal allocation for supplies that are known to have a high statistical association with preferred attributes. However the ideal is chosen it is an aspect that a ideal point is determined along for each association of a supply and a demand, i.e., each path of potential allocation.

The ideal allocation points can be unrealistic. In the case of a zero ideal, for example, it may be known that the demands cannot be met without dipping into some portion of at least some of the supplies with zero ideal allocations. Nevertheless, the ideal values represent goals that are factoring into the allocation as explained herein.

The ideal allocation values for each allocation between an eligible supply and demand are points along each of the multiple axes in multi-coordinate allocation space. Therefore, the combination of all the ideal values corresponds to a single utopia point in multi-coordinate space. It then is possible to compare all possible allocations comprising combinations of quantities of supply to meet quantities of demand, by likewise determining a point to which a possible allocation corresponds, and gauging the proximity between the point and the utopia point. A norm function can be used to assess such proximity, by calculating the distances from the allocation to the utopia point by one or another measure. An allocation is then planned or finally executed using the optimal allocation found.

The availability of ad impressions is within the control of network operators and information distributors, including entities such as web site operators for products or services or information, Internet service providers, email exchange services and the like. These entities have their own business purposes but often are willing to agree with advertising distributors to carry advertising for others in exchange for some sort of remuneration.

The remuneration that can be demanded in exchange for running an ad is a function of the character of the ad and also the extent to which the persons who view the ad are important for the advertiser to target according to the advertiser's business purposes. For example, an advertiser may be willing to pay more to show large and prominent ads than discreet ones. The advertiser may be specifically interested in targeting viewers of a particular description, such as certain genders or age groups, perhaps in certain geographic locations, and be willing to pay media distributors a premium to insert ads on websites or other media outlets that are patronized by those viewers.

In the present context, the “supply” comprises opportunities to place advertising content. The opportunities can be spaces where graphics may be inserted on web pages, time periods in sequences of media programming or the like. Such forms of media are presented on user readout devices such as personal computers, wireless devices, entertainment consoles and receivers for radio or audiovisual programming. Thus each element of the supply is a space and time, or similarly defined place, in the time and/or space occupied by the readout of a user device, preferably when actually in use.

Likewise, the “demand” is a desire to put one's advertising content, whether text, graphics, video, sound or combinations of different sorts of content, into the space where the supply or opportunity arises. This demand is typically related in part to the nature of the supply. There may be greater demand to place content in places visited frequently by customers of a type who are highly interested, than in other places. According to the present disclosure, the supply or opportunity (the ad impression) and also the demand or desire to use the supply, is defined by first collecting information that characterizes the environment of the supply. Allocating the supply to the demand is associating together a particular ad impression (opportunity) with the advertiser who bargains for that ad impression. Allocation can be a matter of planning, but the relationship is consummated by an exchange of deliverables, namely transmitting or inserting the ad content that was designated by the advertiser, into the place and at the time corresponding to the ad impression opportunity. This is regarded as providing or allocating the ad impression to the demand in this description, but is should be recognized that the supply is a number of opportunities, and the supply is not delivered to the demand as might characterize physical goods. Instead, the supply (the opportunity) is exploited by using the supply to display or play back the advertising content designated by the advertiser in exchange for the advertiser's payment.

The media operator, such as a web page operator, decides whether there shall be an opportunity to insert an ad. The operator of a web page may recognize that web page information and graphics has room to carry ads and that audio clips could be played. A broadcaster may decide that commercial ads can occupy 15 or 30 second time slots for three minutes for every 20 minutes of programming, which constitutes a supply. Specifications for the size, type, time of day and similar attributes of the advertising opportunity are reported to a data processor or service. Likewise, attributes of the users (either projected or actual) are associated by the processor with the advertising opportunities. The user attributes can be inferred in part from the nature of the content and/or the user attributes can be determined from other sources such as the users' browsers. These define the supply.

In connection with negotiations for exploiting opportunities to display ads, the media operators or outlets specify the nature of ad impressions that are offered, and the advertisers select among them based on advertisers' specifications. The advertisers may act individually or through advertising services and middlemen. The specifications describe aspects of the ad space such as the nature and size of a graphic or animation or video, its time of presentation and duration, and also describe the environment. The environment includes the nature of the content with which the ad will appear and may also include information about the expected viewer base. Ad impressions can be variable or can have predetermined characteristics, for example, the size and prominence of an ad can be controllable variables. Ad impressions can be specified by the nature of the accompanying content into which the ad is inserted or with which the ad is interleaved. The accompanying content is within the control of the media operator and may be important to the advertiser in deciding whether the viewers of such content are appropriate advertising targets. The accompanying content may be the information contained in a web page that is operated by a certain kind of entity and may have a function that is particularly appealing to viewers of a certain description. The media outlet collects information that characterizes its viewers or users that patronize the media outlet. This information can be made available to potential advertisers when negotiating advertising terms, and enables an advertiser to place ads with media outlets that are patronized by the potential customers that the advertiser wants to reach.

This information is reported to the processor 30 shown generally in FIG. 1. The processor 30 carries on or supports a number of functions shown in FIG. 2. The processor is configured as a data processing subsystem of a computer associated with the media supplier, which is coupled for data communications, for example to provide media in the form of html web pages and graphics files over a communication path traversing the Internet to various remote users. The media supplier can be associated with a service such as a directory service or search engine, or a retail or wholesale outlet or any of various operations whose activities include transmission of media to users.

One or more data processors are included using general or special purpose processing engines such as a microprocessor, controller or other control logic configuration. A processor may be coupled in known manner via a bus to program and data memory, an interface for input/output with a local operator, including, for example, a keyboard, mouse, display, etc., and a communications interface for passing data between advertisers and media suppliers. The communications can generally be Internet or other network communications, with parts of the exchanged information potential being by off-line communication techniques.

The computing system contains data and program memory such as volatile RAM, ROM, disc or flash nonvolatile RAM memory, etc. Program instructions are stored in and executed from the program memory to carry out the functions discussed herein. The memory can include persistent data storage for accumulated data respecting advertiser and user information, for example on hard drives. The processor can contain locally stored versions of advertising copy that is to be inserted by the media distributor 24 in communications to users, obtained from or approved by the respective advertisers 22.

Alternatively or in addition, at least part of the advertising copy to be inserted can be stored remotely and accessed by providing to the browser at the user system the appropriate URLs identifying advertising content to be inserted. The advertising range from simple textual graphics to animations, drawings, video motion pictures or links to further information, among other possible inserts.

For such inserts, persistent storage devices may be provided at the media supplier and/or processor, such as a media drive and a storage interface for video or other substantial storage capacity needs. The program coding, media inserts and distributed media content can be stored wholly or partly in a computer readable medium. The at similar terms in this disclosure such as “computer program medium,” “computer useable medium,” “data memory” and the like are used generally to refer to media involved in carrying one or more sequences of one or more instructions for execution by the processor. Such instructions, generally referred to as “computer program code” (which may be grouped in the form of computer programs or other groupings), when executed, enable the processor and the system as whole to perform features or functions of the embodiments discussed herein.

The processor operates to determine an allocation of available supplies, namely ad impressions that arise as opportunities or are projected to arise, to meet demand. This operation can be conducted tentatively when negotiating with media distributors and advertisers who are considering entering an advertising relationship or contract, using ad impressions that are projected to become available. In that case, the result can be a commitment or contract to make available a certain number of the projected ad impressions of stated characteristics, so that advertiser selected inserts can included when the associated content is delivered by the media distributor to users. In another phase of operation, the same operations can be used to control the current allocation of ad impressions that arise, in order to meet the demands. In that phase, each delivery to a user according to the chose one or more allocations will meet an incremental part of one of the competing demands that are satisfied.

The task of allocating ad impressions (supply) to meet the advertiser's representative profile (demand) is modeled as a linear network flow problem. A typical network flow solver may generate corner solutions, which are to be avoided in this context. Corner solutions might favor the first request, or requests with some association or valuation aspect that enables a demand to hog a disproportionate part of one or more of the supplies. One object is to use an allocation the facilitates spreading the association of supplies and demands to obtain a representative advertising profile.

As shown in FIG. 2, a programmed function or service of the processor can manage the allocation of the supply of ad impressions available from subscribing website operators and similar media outlets versus the demand by advertisers to use the ad impressions, optionally providing the interface through which ad content is routed to the media outlets for insertion, as windows, banners and other elements of webpages being composed for display by the respective browser programs that compose the webpages for viewing by users, e.g., when surfing the worldwide Web.

An advantageous embodiment supported by user interfaces for the advertisers and media distributors or outlets is configured to manage allocation of guaranteed-delivery ad impressions in a number projected by media distributors to be available, and also to manage the offering and sale ad hoc of excess ad impressions that are found to be available beyond those that were projected. These excess impressions can be sold at auction and used up to the time at which it becomes apparent that the number of impressions in the actual supply will exceed what was projected.

The marketplace arrangement as shown in FIG. 2 can unify the allocation and sale of ads, eliminating any artificial separation between the ad impression inventory that is sold months in advance under agreements entailing guaranteed delivery (i.e., obligations as to the number and nature of impressions and potential penalties for inability to deliver) versus the remaining inventory, normally from overly-conservative estimates and projections, to be sold using a real-time auction, spot market or terms of “best efforts” non-guaranteed delivery.

An advertising distribution as shown provides automated allocation and management of non-guaranteed delivery impressions, including allocation and contractual commitment of ad impressions immediately prior to the time that the impressions become available, a mix of guaranteed and also non-guaranteed contracts can form a unified marketplace whereby an impression can be allocated to a guaranteed or non-guaranteed contract efficiently, based on the value of the impression to the different contracts, and with less value risked on the ability to project ad impression availability far in advance. A unified marketplace for long term (guaranteed) impressions and short term ones as well, enables equitable allocation of ad impression inventory, and promotes increased competition between guaranteed and non-guaranteed contracts.

Advertising demands specify a selection from available ad impressions and may be broad or narrow. A demand specified as the ad impressions of “one million Yahoo! Finance users from 1 Aug. 2008-31 Aug. 2008,” for example, is relatively diluted and potentially less valuable to certain advertisers compared to a more narrowly targeted demand, such as “100,000 Yahoo! Finance users from 1 Aug. 2008-8 Aug. 2008 who are males between the ages of 20-35 located in California, who work in the healthcare industry and have recently accessed information on sports and autos.”

The processor preferably forecasts and later allocates ad impressions using a reasonably fine-grained level of targeting, using a relatively large number of variables and tests with tight ranges or close adherence to examples. Advantageously, if targeting attributes are not known, they can nevertheless be used in selection criteria by relying on correlation of known and unknown variable values, to allocate ad impressions with demand. Taken to a fine level, it may be possible and appropriate to match variable values with many targeting attributes and supporting the ability of different advertisers to specify different targeting combinations according to variables that are meaningful to those advertisers, even though the targeted subsets overlap.

In FIG. 2, the advertising delivery system 100 coordinates the execution of various system components, operating as a server with several subsystems devoted to arranging for handling the contractual matching of guaranteed ad impressions allocated to demands according to projections and serving ads to fill the ad impressions. An admission control and pricing sub-system 102 facilitates guaranteed ad contracts, preferably for a time period up to a year in advance of actual presentation of ad impressions that are contracted. This sub-system 102 assists in pricing guaranteed contracts, and is coupled to supply and demand forecasting subsystems for this purpose. An ad serving sub-system 104 has a subsystem that matches ad guarantees (demands) with opportunities (ad impressions).

The admission control module 102 has input and output signal paths for interacting with sales persons who negotiate and contract with advertisers. A sales person may issue a query that defines a specified target (e.g., “Yahoo! finance users who are California males who like sports and autos”) and the Admission Control module determines and reports the available inventory of ad impressions for the target and the associated price. The sales person can then book a contract accordingly.

When delivering ad impressions, the ad server module 104 takes on an ad impression opportunity, which comprises a user such as a web page viewer and a context, such as a URL for the visited page and information on the theme of the content of the web page begin viewed. The ad server module 104 allocates the ad impression by returning the advertising copy of an advertising insert or a link to the copy, which is then inserted into the media content otherwise provide by the corresponding media supply to its user of viewer. The operation of the system is orchestrated by an optimization module 110. This module periodically takes into account a forecast of supply (future impressions can be projected and allocations adjusted from time to time). A supply forecasting module 113, and two demand forecasting modules 115, 117 are provided, the demand forecasting modules advantageously distinguishing between contractually guaranteed ad impressions and non-guaranteed ad impressions that arise. As ad impressions are made available, the system can decide whether to use the ad impression to satisfy the guaranteed commitments or to apply them to the spot market.

The optimization module serves to allocate incremental ad impressions that arise (or that are projected) for the supply to meet incremental demands that are predetermined (or are being negotiated). The optimization module sends a summary plan characterizing the optimization results to the admission control and pricing module 102 and to a plan distribution and statistics gathering module 112.

A practical solution for handling the allocation of supplies to demands comprises a series of steps. A set of characteristic attributes is determined to define each of plural categories of ad impressions, which are deemed supplies. Some number of ad impressions will become available that fall into each of the categories of supply. Likewise, a set of characteristic specifications is obtained for each of the demands. The demand specifications can correspond to the supply attributes or can be related to the supply attributes, e.g., by statistical correlation. The supply attributes and the demand specifications, and any functions that arise from them (such as Boolean combinations) are sufficient to enable a decision as to whether or not each of the supplies is eligible to contribute ad impressions toward meeting each of the designs. Such a decision is made that links each eligible pair of supplies and demands.

The various supplies that meet the various demands are not identical, and as a result there are differences in the value of some supplies if associated with some demands. Some ad impressions are more valuable than others. Some demands are more crucial than others. There are some supplies that are more appropriately used to meet certain demands and are less appropriate for others, although still possible. These variations in the absolute values of supplies, variations in the value if one alternative allocation over another, and the appropriateness of alternative allocations, are encoded in two ways.

For each associated supply and demand, a value weight factor can be assigned to encode the relative value of an allocation from each given supply to each eligible demand. Also, for each associated supply and demand, an ideal allocation can be assigned. The ideal can be a number of allocated supply units, or a weighted value or a proportion of the associated supply or demand. Thus, for every associated supply and demand, there is a relative value and a measure of the extent of allocation that might be considered ideal.

Determining the ideal allocation is a matter of applying goals. From the media supplier's standpoint, an ideal allocation may be to allocate a low number or a low proportion of all valuable ad impressions. From an advertiser's standpoint, an ideal allocation may bias the allocations of certain supplies to certain demands on grounds of selected ad impression attributes for targeting purposes, while preserving a representative spread as to other ad impression attributes. In the same way that weighting causes differences in ad impression value to be taken into account, setting an ideal allocation point higher or lower enables ad impressions to be biased respectively toward or away from use for a given demand. Also, setting ideal allocations points equal to the same proportion of the total number of ad impressions in each distinct supply category produces a spread of allocations based on the number of ad impressions. Setting the ideal allocation point equal for two or more supply categories may bias the allocation toward disproportionately depleting one of the supply units.

All such choices are made to achieve goals. Possible goals include, without limitation, preserving the value of reserved ad impressions (those not yet allocated), targeting by attribute matching of particular supply categories and demand specifications, achieving a spread of allocations over representative supplies and demands, biasing a spread of allocations over supplies and demands based on one or more attributes, etc.

When projecting into the future, for example when negotiating agreements with advertisers and media distributors for future-performance by delivery of a given number of ad impressions of predetermined specifications and at an agreed price, the number of supply units having given characteristic attributes must be projected. During that phase, alternative sets of demand specifications can be proposed, and if not susceptible to agreement, a new alternative can be proposed.

When actually performing by delivering ad impressions, the allocated numbers are counted. The delivered number of supply units having a given set of attributes and the predetermined number of ad impressions meeting the predetermined specifications are respectively decremented and incremented. During such performance, new projections can be generated periodically to adjust the ongoing allocation of supplies to demands and thus adapt to any differences between projections and reality.

The processor memory is thereby populated with information that determines the eligibility of each supply to each demand, a weight (which is greater than or equal to zero and may be more or less then one) that distinguishes the relative suitability of one allocation versus another, and a scale for use as measure of units allocated. The scale is from zero to the maximum available number of ad impressions. (Corresponding scales are the value and the weighted value of ad impressions allocated from zero to a maximum.) One point on the scale represents the assign ideal allocation based on goals.

A next step is to determine, out of all the different numbers of units and different combinations of allocations that might be made, wherein different numbers of ad impression units might be doled from different supplies to meet different demands, which particular allocation will be used. This step is to determine the optimal allocation. The optimal allocation is a particular planned allocation during negotiations, and it is a control point during actual performance of ad impression delivery. The processor determines and then seeks to control to achieve a particular number of allocations taken from each respective one of the supplies and applied to each eligible demand associated with that one of the supplies.

Given that there is a scale from zero to the maximum number (or weighted number or value) of ad impressions in each given supply, it is not possible to allocate any number of supply ad impressions to any number of eligible demands because certain constraints apply in a manner that cause any allocation of one or more ad impressions to a demand to reduce the number of ad impressions that are available for allocation to some other demand.

There are an unlimited number of solutions for allocations that meet the constraints associated with getting the job done (meeting the demand). In the optimizer function of the processor, all or a representative sampling of possible allocations are attempted and compared by data processing steps to determine which of the solutions most nearly approximates the ideal points in the allocation scales of all the pairs of supplies and their one or more eligible demands.

The solution computed in this way can be more or less finely granulated. For example, if one solves and compares all possible allocations down to the level of single ad impressions, the computing job is greater than solving increments of several ad impressions. That is, the units of ad impressions can be single units of one or multiple units of five, ten or a hundred ad impressions, etc., which reduces the computational load.

By data processing techniques, a multi-coordinate space is defined, wherein each coordinate axis correspond to the scale pairing each eligible supply and eligible demand with one another. An ideal point on each scale (or at least on some subset of the scales) has been assigned. Where the scales are common to a particular supply, it is known that the sum of allocations to the demands shall be less than or equal to the number of ad impressions in the supply. Therefore, a potential allocation is a point along the coordinate axis representing a measure of allocation from that supply to that demand and increasing the point on one scale associated with a demand decreases the allocation available to any others.

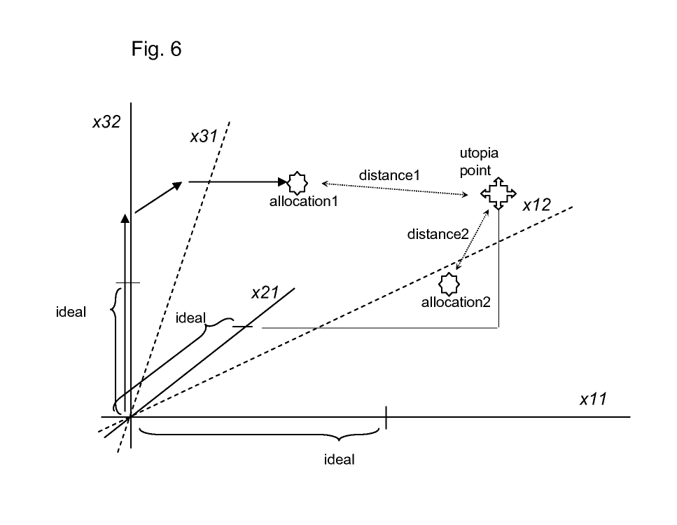

The coordinate axes can be accorded different weights to distinguish a value or other distinguishing aspect of one allocation from a supply to a demand, versus another. The predetermined ideal allocation for a given supply to a given demand is a point along the corresponding axis in multi-dimensional space, somewhere between zero and the full amount of the eligible supply. In the multi-coordinate space, the ideal allocation (which might or might not be a feasible allocation) is a single point in the multi-coordinate space, namely the point having variables equal to the respective allocations of every supply to every eligible demand. This is a utopia point, shown in FIG. 6. In the multi-coordinate space, the proposed or actual allocations likewise correspond to a single point in the multi-coordinate space. The processor computes the proximity of any proposed allocation to the utopia point, and in that way compares or sorts among the possible allocations to determine an optimal allocation or to rate to or more possible allocations as to which is closer to the utopia point. The planned or actual allocation is determined in this way. When performing the delivery of ad impressions the processor uses the planned allocation as a control value. The control value can be updated periodically to re-optimize as ad impressions are delivered.

By data processing techniques, a plurality of possible allocations between the eligible supplies and demands are tested to determine one or more allocations that best matches all the ideals. Preferably, all the possible allocations are tested. Every possible set of allocations between all the supplies and all the eligible demands represents a point in multi-coordinate space. However, not all the points in multi-coordinate space are possible. This is true because in cases where portions of a supply can be allocated to two or more demands, increasing the allocation to one of the demands has the effect of decreasing the quantity and proportion of that supply that remains available for allocation to another demand.

Given the allocation plan as described, the admission control and pricing module 102 of the processor works as follows. When a sales person issues a targeting query for some duration in the future, the system first invokes the supply forecasting module 113 to identify how much inventory of ad impressions available for that target and duration. The admission control module 102 uses the plan computed by the optimization module 110, using default or prompted input values to arrive at weights and ideals as to allocation numbers or proportions or values. The numbers, proportions and values are units that can be algebraically equated, given the number of ad impressions and other input data. A distribution of ad impressions is planned by the optimizing steps discussed above and stored. The optimized plan can be the subject of negotiations. Reports can be generated to test the optimized plan by applying if/then tests to see how the optimized allocation would respond if different supply scenarios were realized. The weights and ideal allocation numbers can be tweaked and new allocations generated. Eventually, an optimized allocation plan is reached.

The ad server module 104 works as follows. When an opportunity is presented, for example because a user's browser is engaged in generating the display of a web page from html data and encounters a graphic that is linked to a web address associated with the ad server, an IP call is made for associated media content (e.g., text, graphics, animation, etc.). The ad server module determines the supply category of the associated ad impression. The ad server accesses memory registers containing stored counts of projected ad impressions and actual ad impressions used for that supply category and the counts of demand impressions projected and demand impressions used for all eligible supplies that are coupled to that supply category. The ad server module determines based on numbers or proportions which of the demands has a shortfall in allocations compared to the optimized allocation plan and allocates the emergent ad impression to that demand. Allocation comprises coupling the advertiser's content to be used in rendering the web page by the user's browser. The counts of actual and projected supplies and demands are adjusted. If none of the demands shows a shortfall in allocations, the allocation can be made by random selection of an eligible demand or by a round robin technique so that the available supply is spread among the eligible demands.

Determining the optimal allocation as described uses an allocation model wherein multiple objectives are encoded by associating supplies and demands based on eligibility, weighting and ideal allocation values that seek one or another of minimizing allocation, maximizing allocation, distributing a supply allocation as a function of the supply or as a function of the number of contributing supplies and/or served demands, and biasing the allocations based on variable values. The result is an allocation that is closest to the utopia point. The possible allocations are limited by constraints including the reality that some of the supply must be used, all of the demand must be satisfied, and preferably all of the supplies will be tapped in the process of meeting all of the demand.

The remaining step concerns how to determine which of all the possible solutions is optimal. The optimal solution is determined by finding the coordinate points in multi-dimensional space for each potential allocation. Each potential allocation has associated points on scales representing the allocation from each eligible paired supply and demand. These points on the scales are coordinate positions in multi-dimensional space (i.e., a space having mutually orthogonal coordinate axes for every eligible pair of one supply and one demand). The points on all the scales provide a coordinate address in multi-dimensional space. The proximity of the coordinate address of an allocation to the coordinate address of the utopia point determines the proximity of the allocation to the utopia point and is used to select or to rank allocations based on their proximity to utopia.

The determination of proximity can be made in different ways based on use of different norm functions. Examples provided are the l₁ norm and l_{∞} norm, wherein a best match is sought using linear programming (LP), and the l₂ norm, wherein the comparison is considered by quadratic programming (QP). Both LP and QP solutions can be reached efficiently and at high speed by existing computational processors and programs. The solution involves characterizing the association of each category of a supply and an eligible demand as a coordinate axis in multi-dimensional space. The supply comprises some number of available or projected ad impressions having predetermined attributes. The eligible demand comprises some number of demand specifications with attributes that correspond with the attributes of the supply, at least to a threshold of eligibility. An allocation of a given number (or proportion or value) of the supply to the demand is a point along the axis. The points along all the axes pairing an eligible supply and demand in an ideal allocation corresponds to one point in the multi-dimensional space, which is the utopia point. The points along all the axes pairing an eligible supply and demand in an actual allocation also correspond to points in the coordinate space. Not all points in the space are potential allocations because the allocations are constrained by limitations including that the allocation to a demand is equal to the sum of allocations from the supplies, and each supply has finite number of supply units.

It is assumed that there are a number m of ad impression instances (whether actual or projected) in a supply s and a number n of demand impressions d. The allocation problem is to match each instance sᵢ (where i ranges from 1 to m) with an instance dⱼ (where j ranges from 1 to n). An allocation xᵢⱼ of an instance or incremental volume from sᵢ to dⱼ is an incremental part of the overall allocation. When planning an allocation, it is necessary to determine an appropriate set of xᵢⱼ matches. Accordingly, the notation to be applied is shown in Table I:

TABLE I

i: index of supply, i = 1, . . . , m
j: index of demand, j = 1, . . . , n
sᵢ: volume of supply i
dⱼ: volume of demand j
vⱼ: value or priority of demand j
xᵢⱼ: allocation volume from supply i to demand j

In a single demand case, each of the supply instances can be allocated only to the one demand, although one might have supplies with multiple instances in each category. One could model the situation as multi-objective optimization where it is desired to choose a minimum x₁ where all the individual allocations xᵢ₁ are minimized simultaneously. None of the allocations can exceed the corresponding increment of supply. The sum of the allocations is exactly equal to the demand. And each of the allocations is zero or greater. The expressions (where “min” denotes “minimum” and “s.t.” denotes “such that”) are:

$$min {x}_{1} = ( {x}_{11} , {x}_{21} , … , {x}_{m 1} )$$

$$s . t . {x}_{i 1} \leq {s}_{i} , ∀ i$$

$${\sum }_{i} {x}_{i 1} = {d}_{1}$$

$${x}_{i 1} \geq 0 , ∀ i$$

A further objective is added that the allocation needs to be selected based on proximity to an ideal allocation in space, determined by one or another desired norm function. The ideal allocation can be considered the representative profile of an advertiser (a demand specification) as modified by objectives of the advertiser and the media distributor. The following expression is solved for all the associated allocations of supply and demand, to select a solution with a minimum difference between the allocation and the ideal:

$$min = ‖ {x}_{1} - {\overline{x}}_{1} ‖$$

$$s . t . {x}_{i 1} \leq {s}_{i} , ∀ i \\ {\sum }_{i} {x}_{i 1} = {d}_{1} \\ {x}_{i 1} \geq 0 , ∀ i$$

where x̅=( x̅₁₁, x̅₂₁, . . . , x̅ₘ₁) is a utopia point and ∥•∥ is a norm operator.

The norm operator represents the difference between the allocation under consideration and an ideal allocation. The ideal allocation is a point in multi-dimensional space but need not be a feasible allocation (hence the term “utopia”). The allocations under consideration are feasible allocations, constrained by requirements that the sum of supplies correspond to the paired demands, and the demands are to be met.

There are a number of norm operators that might be used to calculate a distance in multi-coordinate space. In general, a norm is used to gauge a distance or proximity in multi-dimensional allocation space between the allocation under consideration and the utopia point. In allocation space, the measure each of the coordinate axes can be the number of supply increments (ad impressions) allocated from the associated supply to the associated demand. This measure does not take into account the fact that one pairing of a supply and an eligible demand may be preferred over another, which is a reason for weighting the scales so that one allocation route is deemed more important or valuable than another. In that case, a higher weight accorded to a coordinate axis computes to determine a greater effect for a difference in number of ad impressions than the same number on an axis accorded a lesser weight.

Accordingly, in one embodiment, a weighted l₁ norm is used, with the differences along different coordinate axes carrying potentially different weights and the absolute values of the differences along each axis being summed. This norm operator is similar to a situation in two dimensions where one calculates the walking distance between points constrained by city blocks, where one must proceed only in perpendicular directions. The l₁ norm is a linear programming solution that is readily computed and is a measure of proximity between the utopia point and a point in multi-coordinate space corresponding to a proposed or actual allocation.

According to a second embodiment, a weighted l₂ norm can be used where weighted differences are squared and summed, and the square root of the sum represents a straight line difference between two multi-dimensional points. The l₂ norm is a quadratic programming solution.

A third embodiment is base on a weighted l_{∞} norm. In that event, the distance from the utopia point is defined as the maximum difference in any dimension for each allocated increment. This is also a linear programming solution. The three exemplary norm equations, which are alternatives, are represented as:

$${‖ {x}_{1} - {\overline{x}}_{1} ‖}_{1}^{w} = {\sum }_{i = 1}^{m} {w}_{i} \vert {x}_{i 1} - {\overline{x}}_{i 1} \vert$$

$${‖ {x}_{1} - {\overline{x}}_{1} ‖}_{2}^{w} = \sqrt{{\sum }_{i = 1}^{m} {w}_{i} ( {x}_{i 1} - {\overline{x}}_{i 1} \vert}$$

$${‖ {x}_{1} - {\overline{x}}_{1} ‖}_{∞}^{w} = max \{ {w}_{i} \vert {x}_{i 1} - {\overline{x}}_{i 1} \vert , ∀ i \}$$

where w=(w₁,w₂, . . . ,wₘ)≧0 is the weight vector and can be different for each supply index value i.

A possible situation is that the utopia point is zero on all coordinate axes. In that case, x̅ᵢ₁=0 and the weight factor is the reciprocal of the extent of the supply:

$${w}_{i} = \frac{1}{{s}_{i}} .$$

The l_{∞} norm equation can be written as a linear programming model as follows:

$$min = ‖ {x}_{1} - {\overline{x}}_{1} ‖$$

$$s . t . {x}_{i 1} \leq {s}_{i} , ∀ i \\ {\sum }_{i} {x}_{i 1} = {d}_{1}$$

$$\frac{{x}_{i 1}}{{s}_{i}} \leq {y}_{1} , ∀ i$$

$${x}_{i 1} \geq 0 , ∀ i$$

The solution achieves proportional allocation, i.e.,

$$\frac{{x}_{i 1}}{{s}_{i}} = \frac{{x}_{j 1}}{{s}_{j}} .$$

The multi-objective version of the optimization model is shown in FIG. 5. In this illustration it is possible to choose to satisfy a given demand with alternative ones of the supply ad impression instances. However the ad impressions may have different particular characteristics and are encoded to different points in multi-coordinate data space. Optimization entails a selection of which ad impressions shall be allocated to which demands. It is also possible as shown in FIG. 5, that constraints may apply that prevent an allocation, such as the case in the drawings where source s₂ is not selectable to supply demand d₂, for example. In this case, the optimization can be termed as follows:

$$\begin{matrix}min x = ( {x}_{1} , {x}_{2} , … , {x}_{m} ) \\ = ( {x}_{11} , {x}_{21} , … , {x}_{m 1} , … {x}_{1 n} , {x}_{2 n} , … , {x}_{mn} )\end{matrix}$$

$$s . t . {\sum }_{j} {x}_{ij} \leq {s}_{i} , ∀ i$$

$${\sum }_{i} {x}_{ij} = {d}_{j} , ∀ j$$

$${x}_{ij} \geq 0 , ∀ i , j$$

The optimization problem for plural supplies and plural demands is solved by goal programming using a norm function as described:

$$min = ‖ x - \overline{x} ‖$$

$$s . t . {\sum }_{j} {x}_{ij} \leq {s}_{i} , ∀ i$$

$${\sum }_{i} {x}_{ij} = {d}_{j} , ∀ j$$

$${x}_{ij} \geq 0 , ∀ i , j$$

In the case where the ideal value is not specified, x̅ᵢⱼ=0, ∀i,j, one equivalent linear programming model is:

$$min {\sum }_{j} {v}_{j} {y}_{j}$$

$$s . t . {\sum }_{j} {x}_{ij} \leq {s}_{i} , ∀ i$$

$${\sum }_{i} {x}_{ij} = {d}_{j} , ∀ j$$

$$\frac{{x}_{ij}}{{s}_{i}} \leq {y}_{j} , ∀ i , j$$

$${x}_{ij} \geq 0 , ∀ i , j$$

This solution likewise results in a distribution of allocations as described above in the single demand example.

As disclosed and exemplified above, the present developments provide a method for managing allocation of advertising opportunities to meet demands competing to use the advertising opportunities. The steps involved include configuring a data processing system for storage of information including at least one set of characterizing attributes for each of a plurality of subsets of the advertising opportunities that have values for the characterizing attributes in common. These subsets constitute supplies. Data storage is provided in or made accessible to the data processing system for at least one set of specifications for a plurality of demands competing for the supplies, wherein the specifications for the demands discriminate among the characterizing attributes for the subsets constituting the supplies. The specifications for the demands are compared with the characterizing attributes for the supplies, for determining whether individual supplies are eligible to contribute to individual demands by meeting the demand specifications.

The eligible supplies and demands are paired, each paired association of an eligible supply and demand defining a route of potential allocation from the supplies to the demands. The pairs are construed as mutually orthogonal axes in a multi-dimensional space.

An ideal allocation is determined for each of a plurality of said paired individual supplies and demands, according to at least one measure. An ideal allocation, between zero and a maximum, can be determined for every paired association of an eligible supply and demand. Alternatively, an ideal can be determined for some of the pairs and a default ideal allocation can be assumed for others. In any event, the ideal allocations according to the measure correspond to points on the axes in multi-dimensional space. The coordinates for all the pairs constitute the coordinate in multi-dimensional space for a utopia point.

At least two possible allocations from the individual supplies to the individual demands are then tested or compared, or all possible allocations can be compared and sorted, to determine which of the possible locations is nearer to the utopia point.

Every allocation that might be posited from a given supply to a demand reduces the remainder of the given supply that is available for allocation. Therefore, not all combinations of coordinate positions are possible for axes that involve the same supply. The possible allocations each comprises a measure of apportion from individual supplies to one or more demands paired with the supplies by eligibility. These measures corresponding to coordinates along the axes in the multi-dimensional space, and the combinations of the coordinates on the axes define particular points in multi-dimensional space corresponding to each such possible allocation.

An allocation is selected among the possible allocations (or allocations might be rated or ranked relative to one another) based on the relative proximity of the points in the multi-dimensional space corresponding to the possible location versus the position of the utopia point. Allocating from the supplies to the demands can thus be planned and/or executed by apportionment of the supplies to the demands using a selected one of the possible allocations.

The proximity between the utopia point and the points corresponding to the possible locations (or candidate allocations) in multi-dimensional space can be determined from differences between coordinates of each of the candidate allocations versus the coordinates of the utopia point. The differences preferably are established according to a norm function, and the norm function can involve determining one of a sum of absolute values of differences for determining a block wise proximity, a sum of squares difference for determining a straight line proximity or a maximum difference in any dimension.

As an output after selecting, ranking or similarly comparing possible allocations for proximity to the utopia point, it is possible to stored a record identifying a selected one of the candidate allocations, or to rank a plurality of candidate allocations and store identifications or to sort the allocations in an order. It is also possible to transmit one or more control signals that enable or direct use of the advertising opportunities according to a selected allocation.

In further detail, the subject method includes establishing in data storage at least one corresponding count of the advertising opportunities in each of the plurality of subsets (the supplies) and at least one corresponding count for an amount for each of the plurality of demands, and applying at least one constraint for limiting the candidate allocations. The constraint may include a requirement that the count of each of said demands shall be satisfied from the count allocated from subsets less counts allocated to others of said demand, whereby allocating a portion of one of the supplies to one of the demands reduces a portion of the count available for allocation to others of the demands. Other constraints are possible, such as positively requiring or positively precluding certain eligibility pairings between particular supplies and demands. The utopia point typically violates one or more of the constraints that are applied to all the allocations. The utopia point is a theoretical value that represents the utopia allocation measure for each pair of a demand and an eligible supply and does not take into account the fact that allocating a given amount of the supply reduces the remaining amount available for allocation to other demands.

The invention can be operated as a service that simply compares or ranks alternative allocations, possibly operating as a subroutine of a data processing program. Alternatively, the invention an be built into a computing system for inserting or controlling the insertion of advertising pieces into media content. Thus, the supplies are advertising opportunities, each comprising at least one advertising impression. Allocation includes the actual or planned insertion of the advertising piece is inserted into particular media content, identified as a demand having attributes that may be based on the nature of the content, the expected viewer and other characteristics. The attributes of the supplies that are deemed eligible to meet a demand can be determined at least partly based on categorization of the media content as likely to be viewed by subjects to be targeted or other similar said attributes.

As discussed above, constraints may limit the candidate allocations. According to a further refinement, the measures of the apportions from the individual supplies to the demands paired with such supplies can be weighted. The weighting factors can operate to bias the distances in multi-dimensional space, for example imposing a relative value on the measure of allocation between one supply and a paired demand, that is different from that of the supply and a different demand and/or different from wholly different pairs of a demand and an eligible supply. Preferably, weighting factors are specific to at least a related group of the supplies, for example being related to the perceived value of an advertising impression to the supplier or to a particular demand. A weighting factor or a technique for determining a weighting factor can be assignable to specific ones of the supplies, a related group of the supplies and said paired supplies and demands. The norm function that assesses the proximity of a candidate allocation to the utopia point can apply weighting factors to said measures corresponding to points in the multi-dimensional space, so as to factor in the weighting when determining proximity.

In physical embodiment, the system provides a programmed data processing system for managing allocation of advertising opportunities to demands competing to used the advertising opportunities. A processor is coupled to input and output apparatus, a data memory and a program memory. The processor is operable under control of the program memory to observe a pairing of subsets of the advertising opportunities, constituting distinct supplies, with one or more of the demands to which the supplies are eligible to contribute to meet said demands. The processor is operable to apportion variable portions of the supplies to demands, by storing an indication of apportionments, ranking candidate apportionments and/or directing and controlling such apportionment by signaling.

The processor is operable to store data representing an ideal allocation for each of a plurality of said paired individual supplies and demands, according to at least one measure, wherein measures for all the pairs constitute coordinates in a multi-dimensional space. That is, the processor stores an indication of a point in the multi-dimensional space, such as a set of coordinate values along mutually orthogonal axes, for locating a utopia point. The processor is further programmably operable to test at least two possible allocations from the individual supplies to the individual demands, the possible allocations each comprising measures of apportion from the individual supplies to one or more demands paired with the supplies, said measures corresponding to coordinates of points in the multi-dimensional space. The processor selects between the possible allocations based on relative proximity of the points in the multi-dimensional space to the utopia point and allocates accordingly by one of planning and executing apportionment of the supplies to the demands using a selected one of the possible allocations.

The processor can select and/or rank plural candidate allocations. This operation can be in conjunction with planning a future allocation of the supplies to the demands. Alternatively, the processor can be operable actually to effect the allocation by controlling insertion of advertising pieces into media during distribution of the media. This control can be accomplished by providing ad impression content in a data transmission or providing a link address for finding such content or by signaling to cause the ad impression content to be associated with the demand by other techniques.

The processor preferably also is operable to update a stored allocation of the supplies to the demands to account for ongoing emergence of advertising opportunities and ongoing allocation to match demand and supply.

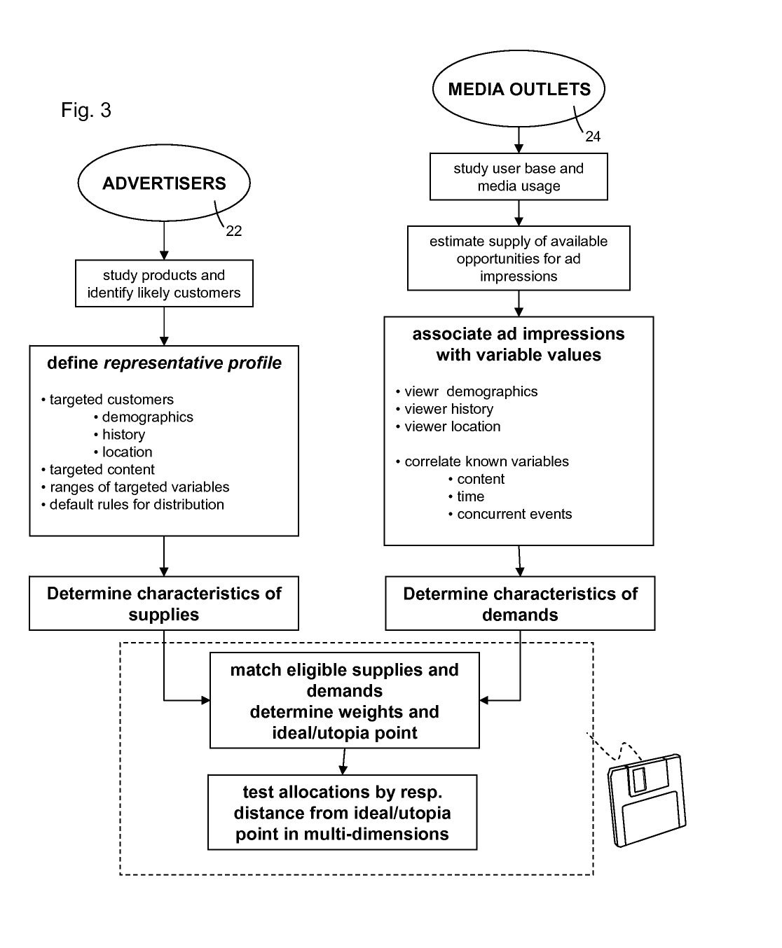

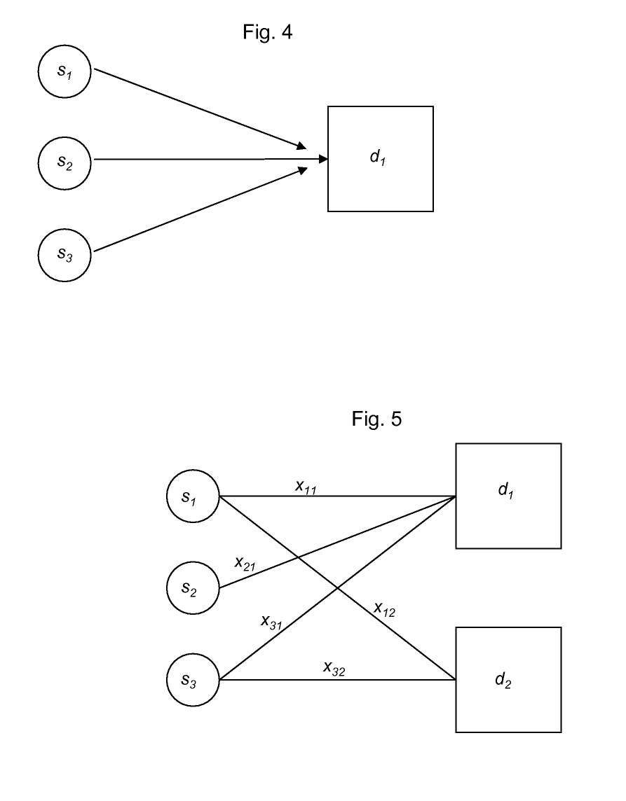

The system preferably is embodied and the method accomplished using a programmed computer system comprising an advertising server with an optimizer function as described. The computer system can include Web based interfaces for input and output to assist in establishing ad impression and representative profile characteristics, to handle the negotiations and entry of contractual commitments and to handle addressing and transmitting the allocated ad content to be inserted into media when viewed. These provisions are operable on general purposed data processing equipment, and can be loaded from a program storage media carrying a program for operation on a processor, generally shown in FIG. 3, coupled to input and output apparatus, a data memory and a program memory, shown schematically in FIGS. 1 and 2, such that the processor is operable under control of the program memory to effect the steps described hereinabove.

The foregoing disclosure provides a range of preferred embodiments as examples, but these examples are not intended to define the scope of the subject matter claimed. Reference should be made to the appended claims.

What is claimed is:

1. A method for managing allocation of advertising opportunities to meet demands competing to use the advertising opportunities, comprising:
configuring a data processing system for storage of information including at least one set of characterizing attributes for each of a plurality of subsets of the advertising opportunities that have values for the characterizing attributes in common, the subsets constituting supplies;
establishing in the data processing system data storage for at least one set of specifications for a plurality of demands competing for the supplies, wherein the specifications for the demands discriminate among the characterizing attributes for the subsets constituting the supplies;
comparing the specifications for the demands versus the characterizing attributes for the supplies, and determining whether individual said supplies are eligible to contribute to individual said demands by meeting the specifications of said demands, and pairing eligible supplies with demands, each paired association of an eligible supply and demand defining a route for allocating from the supplies to the demands;
separately determining an ideal allocation for each of a plurality of said paired individual supplies and demands, according to at least one measure, wherein measures for all the pairs constitute coordinates in a multi-dimensional space, locating a utopia point;
testing at least two possible allocations from the individual supplies to the individual demands, the possible allocations each comprising measures of apportion from the individual supplies to one or more demands paired with the supplies, said measures corresponding to coordinates of points in the multi-dimensional space;
selecting between the possible allocations based on relative proximity of the points in the multi-dimensional space to the utopia point and allocating accordingly by one of planning and executing apportionment of the supplies to the demands using a selected one of the possible allocations.

2. The method of claim 1, wherein the proximity is determined from differences between coordinates of each of the candidate allocations versus the coordinates of the utopia point, the differences being established according to a norm function.

3. The method of claim 2, wherein the norm function determines at least one of: a sum of absolute values of differences for determining a block wise proximity; a sum of squares difference for determining a straight line proximity; and a maximum difference in any dimension.

4. The method of claim 1 selecting between the allocations and allocating comprises at least one of storing a selected one of the candidate allocations, ranking a plurality of candidate allocations, and transmitting control signals for enabling use of the advertising opportunities according to a selected allocation.

5. The method of claim 1, comprising:
establishing in the data storage at least one corresponding count of the advertising opportunities in each of the plurality of subsets and at least one corresponding count for an amount for each of the plurality of demands;
applying at least one constraint for limiting the candidate allocations, the constraint comprising a requirement that the count of each of said demands shall be satisfied from the count allocated from subsets less counts allocated to others of said demand, whereby allocating a portion of one of the supplies to one of the demands reduces a portion of the count available for allocation to others of the demands.

6. The method of claim 5, wherein the utopia point violates the constraint.

7. The method of claim 6, wherein the advertising opportunities each comprise at least one advertising impression wherein an advertising piece is inserted into media content.

8. The method of claim 7, the method of claim 6, wherein the attributes of the supplies are determined at least partly based on categorization of the media content as likely to be viewed by subjects to be targeted.

9. The method of claim 1, comprising:
establishing in the data storage at least one corresponding count of the advertising opportunities in each of the plurality of subsets and at least one corresponding count for an amount for each of the plurality of demands;
applying as a constraint for limiting the candidate allocations, a requirement that the count of each of said demands shall be satisfied from the count allocated from subsets less counts allocated to others of said demand, whereby allocating a portion of one of the supplies to one of the demands reduces a portion of the count available for allocation to others of the demands; and,
employing a weighting factor whereby the measures of apportion from the individual supplies to one or more demands paired with the supplies are determined from a product of a weighting factor and count apportioned from said individual supplies to said one or more demands.

10. The method of claim 9, wherein the weighting factor is specific to at least a related group of the supplies.

11. The method of claim 9, wherein the weighting factor is assignable to specific ones of the supplies, a related group of the supplies and said paired supplies and demands.

12. The method of claim 2, further comprising weighting the norm function by applying a weighting factor to said measures corresponding to points in the multi-dimensional space.

13. A programmed data processing system for managing allocation of advertising opportunities to demands competing to used the advertising opportunities, comprising:
a processor coupled to input and output apparatus, a data memory and a program memory wherein the processor is operable under control of the program memory to observe a pairing of subsets of the advertising opportunities, constituting distinct supplies, with one or more of the demands to which the supplies are eligible to contribute to meet said demands, and the processor is operable to apportion variable portions of the supplies to demands;
wherein the processor is further operable to store data representing an ideal allocation for each of a plurality of said paired individual supplies and demands, according to at least one measure, wherein measures for all the pairs constitute coordinates in a multi-dimensional space, locating a utopia point;
the processor being programmably operable to test at least two possible allocations from the individual supplies to the individual demands, the possible allocations each comprising measures of apportion from the individual supplies to one or more demands paired with the supplies, said measures corresponding to coordinates of points in the multi-dimensional space;
wherein the processor selects between the possible allocations based on relative proximity of the points in the multi-dimensional space to the utopia point and allocates accordingly by one of planning and executing apportionment of the supplies to the demands using a selected one of the possible allocations.

14. The system of claim 13, wherein the processor is operable for at least one of selecting and ranking plural candidate allocations for selecting an allocation in conjunction with planning a future allocation of the supplies to the demands.

15. The system of claim 13, wherein the processor is operable to allocate by controlling insertion of advertising pieces into media during distribution of the media.

16. The system of claim 13, wherein the processor is operable to update a stored allocation of the supplies to the demands to account for ongoing emergence of advertising opportunities.
